(19) United States
(12) Patent Application Publication
(10) Pub. No.: US 2026/0352419 A1
(43) Pub. Date: Nov. 5, 2026

(54) PARALLEL ACKNOWLEDGMENTS FOR COORDINATED BEAMFORMED TRANSMISSIONS

(71) Applicant: QUALCOMM Incorporated, San Diego, CA (US)

(72) Inventors: Sameer VERMANI, San Diego, CA (US); Bin TIAN, San Diego, CA (US); Jialing Li CHEN, San Diego, CA (US); Sherief HELWA, San Diego, CA (US); Alfred ASTERJADHI, San Diego, CA (US); George CHERIAN, San Diego, CA (US)

(21) Appl. No.: 19/199,220

(22) Filed: May 5, 2025

(51) Int. Cl. H04L 5/00; H04B 7/06

(52) U.S. Cl. CPC H04L 5/0055; H04B 7/0632; H04B 7/06952

(57) ABSTRACT

This disclosure provides methods, components, devices and systems for parallel acknowledgments (ACKs) for coordinated beamformed transmissions. Some aspects more specifically relate to a coordination of one or more transmission parameters for the parallel ACKs that are in response to coordinated beamformed physical layer protocol data units (PPDUs). In some examples, a first access point (AP) may communicate one or more frames with a second AP, the one or more frames including information that defines the transmission parameter(s) for the parallel ACKs. The first AP may transmit a first PPDU in accordance with a coordinated beamforming communication scheme between the first AP and the second AP. In response to the first PPDU, the first STA may transmit the first ACK to the first AP in accordance with the transmission parameter(s) defined for the parallel ACKs.

### TECHNICAL FIELD

This disclosure relates generally to wireless communication and, more specifically, to parallel acknowledgments (ACKs) for coordinated beamformed transmissions.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by or at a first access point (AP). The method may include communicating one or more frames with a second AP, where the one or more frames include information that defines one or more transmission parameters for parallel acknowledgments (ACKs) that are in response to coordinated beamformed physical layer (PHY) protocol data units (PPDUs), transmitting a first PPDU in accordance with a coordinated beamforming (COBF) communication scheme between the first AP and the second AP, where the first PPDU includes downlink data addressed to a first station (STA) associated with the first AP and includes a solicitation for a first ACK from the first STA in response to the first PPDU, and receiving the first ACK from the first STA in accordance with the solicitation and in accordance with the one or more transmission parameters defined for the parallel ACKs that are in response to the coordinated beamformed PPDUs.

Another innovative aspect of the subject matter described in this disclosure can be implemented in a first AP. The first AP may include a processing system that includes processor circuitry and memory circuitry that stores code. The processing system may be configured to cause the first AP to communicate one or more frames with a second AP, where the one or more frames include information that defines one or more transmission parameters for parallel ACKs that are in response to coordinated beamformed PPDUs, transmit a first PPDU in accordance with a COBF communication scheme between the first AP and the second AP, where the first PPDU includes downlink data addressed to a first STA associated with the first AP and includes a solicitation for a first ACK from the first STA in response to the first PPDU, and receive the first ACK from the first STA in accordance with the solicitation and in accordance with the one or more transmission parameters defined for the parallel ACKs that are in response to the coordinated beamformed PPDUs.

Another innovative aspect of the subject matter described in this disclosure can be implemented in a first AP. The first AP may include means for communicating one or more frames with a second AP, where the one or more frames include information that defines one or more transmission parameters for parallel ACKs that are in response to coordinated beamformed PPDUs, means for transmitting a first PPDU in accordance with a COBF communication scheme between the first AP and the second AP, where the first PPDU includes downlink data addressed to a first STA associated with the first AP and includes a solicitation for a first ACK from the first STA in response to the first PPDU, and means for receiving the first ACK from the first STA in accordance with the solicitation and in accordance with the one or more transmission parameters defined for the parallel ACKs that are in response to the coordinated beamformed PPDUs.

Another innovative aspect of the subject matter described in this disclosure can be implemented in non-transitory computer-readable medium storing code for wireless communication at a first AP. The code may include instructions executable by one or more processors to (cause the first AP to) communicate one or more frames with a second AP, where the one or more frames include information that defines one or more transmission parameters for parallel ACKs that are in response to coordinated beamformed PPDUs, transmit a first PPDU in accordance with a COBF communication scheme between the first AP and the second AP, where the first PPDU includes downlink data addressed to a first STA associated with the first AP and includes a solicitation for a first ACK from the first STA in response to the first PPDU, and receive the first ACK from the first STA in accordance with the solicitation and in accordance with the one or more transmission parameters defined for the parallel ACKs that are in response to the coordinated beamformed PPDUs.

In some implementations of the method, first APs, and non-transitory computer-readable medium described herein, the first PPDU indicates the first STA to use the one or more transmission parameters for transmission of the first ACK.

In some implementations of the method, first APs, and non-transitory computer-readable medium described herein, the one or more frames may be communicated with the second AP as part of at least one of a COBF agreement establishment phase between the first AP and the second AP, an initial handshake between the first AP and the second AP at a beginning of a transmission opportunity (TXOP) within which the first PPDU may be transmitted, or a group formation between a set of multiple coordinating APs including the first AP and the second AP.

In some implementations of the method, first APs, and non-transitory computer-readable medium described herein, the one or more transmission parameters include an ACK policy for the parallel ACKs that may be in response to the coordinated beamformed PPDUs.

In some implementations of the method, first APs, and non-transitory computer-readable medium described herein, the one or more transmission parameters include a PPDU length for the parallel ACKs that may be in response to the coordinated beamformed PPDUs.

In some implementations of the method, first APs, and non-transitory computer-readable medium described herein, the one or more transmission parameters include a target received signal strength indicator (RSSI) level for the parallel ACKs that may be in response to the coordinated beamformed PPDUs or an upper limit target RSSI level delta between the parallel ACKs that may be in response to the coordinated beamformed PPDUs.

In some implementations of the method, first APs, and non-transitory computer-readable medium described herein, the one or more transmission parameters include a modulation and coding scheme for the parallel ACKs that may be in response to the coordinated beamformed PPDUs.

In some implementations of the method, first APs, and non-transitory computer-readable medium described herein, the one or more transmission parameters include a resource unit (RU) assignment for the parallel ACKs that may be in response to the coordinated beamformed PPDUs.

In some implementations of the method, first APs, and non-transitory computer-readable medium described herein, the one or more transmission parameters include at least one of a guard interval plus long training field (GI+LTF) size or a PPDU format for the parallel ACKs that may be in response to the coordinated beamformed PPDUs.

In some implementations of the method, first APs, and non-transitory computer-readable medium described herein, the parallel ACKs that may be in response to the coordinated beamformed PPDUs include the first ACK in response to the first PPDU transmitted by the first AP and a second ACK in response to a second PPDU transmitted by the second AP and the coordinated beamformed PPDUs include the first PPDU and the second PPDU.

In some implementations of the method, first APs, and non-transitory computer-readable medium described herein, the first ACK and the second ACK may be part of a single wideband orthogonal frequency division multiple access (OFDMA) transmission.

In some implementations of the method, first APs, and non-transitory computer-readable medium described herein, the first ACK may be within a first PPDU transmitted via a first set of one or more channels and the second ACK may be within a second PPDU, independent from the first PPDU, transmitted via a second set of one or more channels.

Details of one or more implementations of the subject matter described in this disclosure are set forth in the accompanying drawings and the description below. Other features and aspects will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example signaling diagram that supports parallel acknowledgments (ACKs) for coordinated beamformed transmissions.

FIG. 6 shows an example communication timeline that supports parallel ACKs for coordinated beamformed transmissions.

FIG. 7 shows an example process flow that supports parallel ACKs for coordinated beamformed transmissions.

FIG. 8 shows a block diagram of an example wireless communication device that supports parallel ACKs for coordinated beamformed transmissions.

FIG. 9 shows a flowchart illustrating an example process performable by or at a first AP that supports parallel ACKs for coordinated beamformed transmissions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, two or more access points (APs) may support a multi-AP coordination scheme, such as a coordinated beamforming (COBF) communication scheme. COBF enables two or more APs to simultaneously transmit to one or more respective stations (STAs) while reducing (such as minimizing or avoiding) interference. As part of a COBF communication scheme, participating APs may coordinate transmit beamforming matrices to create spatially focused transmissions that reduce inter-AP interference, allowing or otherwise supporting concurrent downlink physical layer (PHY) protocol data units (PPDUs) to different STAs via a same bandwidth (such as via a same set of one or more frequency channels). Each AP that is participating in the COBF transmission may procure channel state information (CSI) from a set of STAs (such as all STAs associated with any of the participating APs, including in-basic service set (BSS) STAs and overlapping BSS (OBSS) STAs; in other words, not just the STAs associated with that AP). The participating APs may use such CSI to form beamformed nulls to OBSS STAs.

A STA may respond to a received PPDU with an acknowledgment (ACK) frame, which the STA may transmit after a short interframe space (SIFS) to confirm successful reception of the PPDU. Some systems may utilize a sequential ACK mechanism according to which each STA waits its turn to acknowledge receipt of a PPDU, which may create overhead and inefficiency in coordinated multi-AP environments. In such coordinated multi-AP environments, parallel ACKs (such as simultaneous or joint ACKs, such as ACKs that at least partially, if not completely, overlap in time) may improve network efficiency by allowing multiple STAs to simultaneously transmit their ACKs to their respective APs, reducing the airtime of the complete exchange. Without coordination between the APs participating in the coordinated beamforming, however, parallel ACKs that are in response to coordinated beamformed PPDUs may interfere with each other, potentially causing communication errors. Thus, some networks may benefit from additional signaling-and/or configuration-based mechanisms according to which the participating APs may coordinate on one or more transmission parameters for parallel ACKs that are in response to coordinated beamformed PPDUs.

Various aspects relate generally to such mechanisms that support parallel ACKs for coordinated beamformed transmissions. Some aspects more specifically relate to a coordination (between at least the APs performing the coordinated beamformed transmissions) of one or more transmission parameters for the parallel ACKs that are in response to coordinated beamformed PPDUs, including via which frame exchanges the APs may coordinate on the transmission parameter(s). In some examples, a first AP may communicate (such as exchange, such as transmit and/or receive) one or more frames with a second AP, the one or more frames including information that defines the transmission parameter(s) for the parallel ACKs. The first AP may transmit a first PPDU in accordance with a coordinated beamforming communication scheme between the first AP and the second AP, with the first PPDU including downlink data addressed to a first STA associated with the first AP and including a solicitation for a first ACK from the first STA in response to the first PPDU. Such a solicitation may be an explicit indication or an implicit indication that feedback is requested. In accordance with (such as in response to) the solicitation, the first STA may transmit the first ACK to the first AP in accordance with (such as using, in compliance with, or otherwise based on) the transmission parameter(s) defined for the parallel ACKs.

Particular aspects of the subject matter described in this disclosure can be implemented to realize one or more of the following potential benefits. In some examples, by communicating one or more frames with the second AP to coordinate (such as negotiate or agree) on a definition of the transmission parameter(s) for the parallel ACKs that are in response to the coordinated beamformed PPDUs, the first AP may facilitate (such as support, enable, or allow) greater collaboration between the first AP and the second AP. Such greater collaboration may achieve greater network efficiencies, including greater spectral efficiency, higher throughput (such as higher data rates), and greater network capacity by reducing or avoiding inter-BSS interference between the parallel (such as time synchronized or approximately time synchronized) ACKs. For example, the first STA may transmit the first ACK in accordance with the coordinated transmission parameter(s), which may result in such reduced or avoided inter-BSS interference between the parallel ACKs. Further, by supporting parallel ACKs that are in response to coordinated beamformed PPDUs, various aspects described herein may maintain the spatial separation benefits of coordinated beamforming and reduce the total time to complete the exchange, thereby increasing overall network throughput and reducing latency, among other benefits.

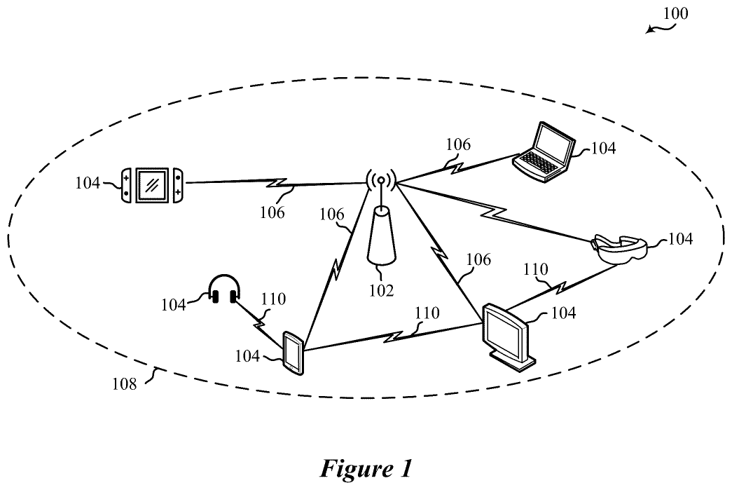

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz 52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS may involve transmission on the primary 20 MHz channel. As such, in conventional systems, the transmitting device may contend on and win a transmission opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an OBSS transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some aspects, an AP 102 may coordinate with one or more other APs 102, such as with one or more other coordinating or “friendly” APs 102, regarding one or more of various parameters, criteria, conditions, or communication schemes/modes related to communication (such as transmission and/or reception) by the AP 102 or the one or more other APs 102. The APs 102 may perform such coordination via a communication (such as an exchange, such as a transmission and/or a reception) of one or more frames that include information that define one or more transmission parameters for the communication by the AP 102 or the one or more other APs 102. Such one or more frames may be management frames, data frames, TXOP sharing (TXS) frames, or any other type of frame that one AP 102 may transmit to one or more other APs 102. The APs 102 may communicate the one or more frames as part of a group formation (such as to form a group of coordinating or friendly APs 102), as part of an agreement phase for a coordinated communication scheme, or as part of a TXOP sharing by one AP 102 with one or more other APs 102.

In some implementations, a first AP 102 may support COBF (such as a COBF communication scheme) with a second AP 102 and may coordinate with the second AP 102 to define one or more transmission parameters for parallel ACKs that are in response to coordinated beamformed PPDUs transmitted by the first AP 102 and the second AP 102. The first AP 102 and the second AP 102 may transmit a first PPDU and a second PPDU, respectively, in accordance with the COBF communication scheme between the first AP 102 and the second AP 102. In some aspects, the first PPDU and the second PPDU may indicate at least one of the transmission parameter(s) defined for the parallel ACKs that are in response to the coordinated beamformed PPDUs (such as the first PPDU and the second PPDU). In examples in which the first PPDU includes downlink data addressed to a first STA 104 associated with the first AP 102 and in which the second PPDU includes downlink data addressed to a second STA 104 associated with the second AP 102, the first STA and the second STA may transmit a first ACK and a second ACK, respectively, in accordance with the transmission parameter(s) defined for the parallel ACKs. As described herein, an “ACK,” including a parallel ACK, may be or may refer to a block ACK (“Block-ACK”). Thus, in some scenarios, “parallel ACKs” may be or may refer to “parallel block ACKs.” A STA 104 may transmit a block ACK to acknowledge a receipt of multiple data packets via a single frame, instead of sending individual acknowledgments for each of the multiple data packets.

The first ACK may be in response to the first PPDU and the second ACK may be in response to the second PPDU (such that the first ACK and the second ACK may be the parallel ACKs that are in response to the coordinated beamformed PPDUs). In accordance with being parallel ACKs, the first ACK and the second ACK may be (approximately) aligned or synchronized in time. In some aspects, being approximately aligned or synchronized in time may mean starting (and/or ending) within a threshold quantity of time domain units of each other. In some examples, the threshold quantity of time domain units may be a SIFS duration or less. In some examples, the threshold quantity of time domain units may be 1 slot or less. In some examples, the threshold quantity of time domain units may be a 5 microseconds or less, 3 microseconds or less, or 1 microsecond or less, among other examples. In some examples, the threshold quantity of time domain units may be 0, such that the first ACK and the second ACK start and/or end in, for example, in a same symbol (such as a same OFDM symbol).

In some aspects, time synchronization between the parallel ACKs may include, involve, be based on, or otherwise be associated with an expectation for the transmitter (the device that is transmitting the ACK or block ACK) to respond at a time which is +/− (“plus or minus”) a few hundred nanoseconds of SIFS after the end of the PPDU. By way of example, the transmitter may be expected to transmit the ACK or block ACK within +/− approximately 400 nanoseconds of SIFS after the coordinated beamformed PPDUs. In other words, the transmitter may be expected to transmit the ACK or block ACK at a time between SIFS+approximately 400 nanoseconds after the coordinated beamformed PPDUs and SIFS-approximately 400 nanoseconds after the coordinated beamformed PPDUs.

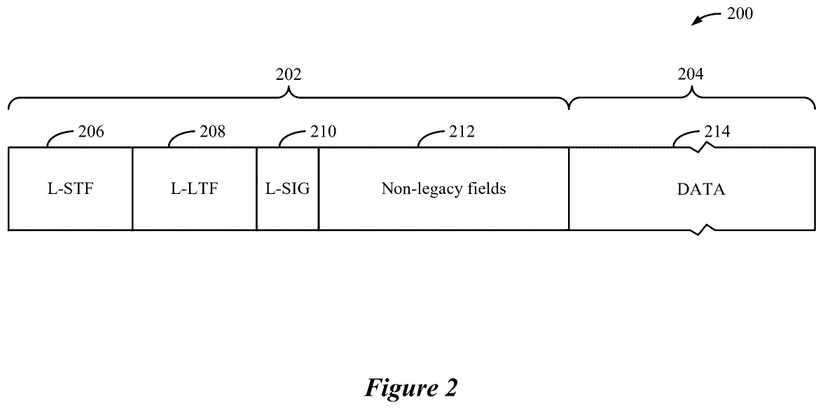

FIG. 2 shows an example PPDU 200 usable for wireless communication between a wireless AP and one or more wireless STAs. For example, the AP and STAs may be examples of the AP 102 and the STAs 104 described with reference to FIG. 1. The PPDU 200 can be configured as a PPDU. As shown, the PPDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some aspects, two (or more) APs 102 may support COBF and transmit respective PPDUs 200 in accordance with a COBF communication scheme. In such aspects, a PPDU 200 may include, in addition to the payload 204, a solicitation (an implicit solicitation or an explicit solicitation) for an ACK in response to the PPDU 200. In some examples, each coordinated beamformed PPDU 200 may include a solicitation for a respective ACK in response to that PPDU 200. Addressed STAs 104 (such as the two or more STAs 104 addressed by the coordinated beamformed PPDUs 200) may transmit ACKs in response to the coordinated beamformed PPDUs 200 and, in some implementations, may transmit the ACKs as parallel ACKs (such as ACKs that are at least approximately aligned or synchronized in time). To support the transmission of parallels ACKs in response to the coordinated beamformed PPDUs 200, each coordinated beamformed PPDU 200 may include an indication of one or more transmission parameters defined for the parallel ACKs. In some implementations, the APs 102 that transmit the coordinated beamformed PPDUs 200 may coordinate on the transmission parameter(s) defined for the parallel ACKs. For example, prior to transmitting the coordinated beamformed PPDUs 200, the APs 102 may communicate (such as exchange, such as transmit and/or receive) one or more frames that include information that defines the transmission parameter(s) for the parallel ACKs.

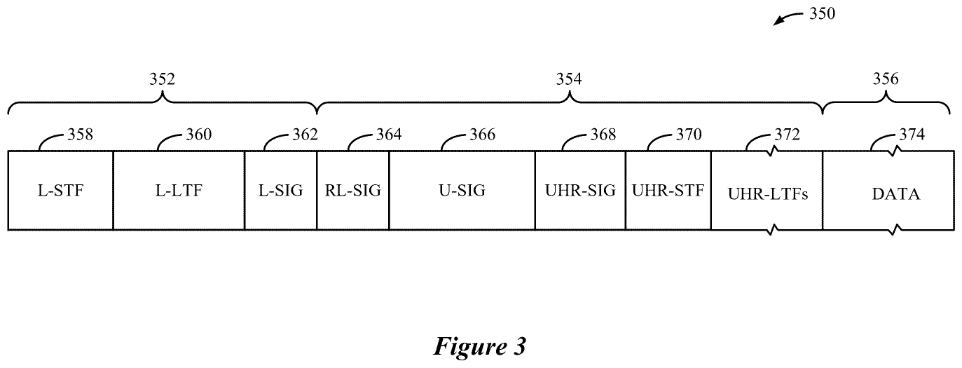

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field (referred to herein as “U-SIG 366”) and a UHR signal field (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field (referred to herein as “UHR-STF 370,” although it may be structured as, and carry version-dependent information for, other wireless communication protocol versions beyond UHR) and one or more additional long training fields (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some aspects, an AP 102 may transmit the PPDU 350 in accordance with a COBF communication scheme. For example, the AP 102 may transmit the PPDU 350 at the same time and via a same set of channels (such as a same channel bandwidth) as another AP 102 that transmits another PPDU. The APs 102 may transmit their respective PPDUs in different directions, such as via different directional communication beams. In some implementations, the APs 102 may support techniques for reducing overhead in COBF transmissions by enabling parallel (such as “joint”) ACK processes, including with a single wideband OFDMA transmission approach that uses different RUs for each BSS to maintain efficient bandwidth allocation or with a two separate (such as independent) PPDUs approach involving symbol alignment and collaboration between the APs 102. Such inter-AP collaboration may involve vendor-specific power control and alignment strategies (such as via one or more vendor-specific frame exchanges). Such implementations to support reduced overhead in COBF transmissions may increase performance and efficiency in wireless communications. Inter-AP collaboration may further support the use of coordinated uplink OFDMA for an ACK transmission in response to COBF (which may be understood as a “joint COBF ACK”), with one or more coordinated (such as collaborated) transmission parameters for the parallel or joint ACKs including at least one of an ACK policy for the parallel ACKs, a same duration for the parallel ACKs (for time alignment), power control for the parallel ACKs, preamble construction for the parallel ACKs, or RU allocation (such as RU assignment) for the parallel ACKs.

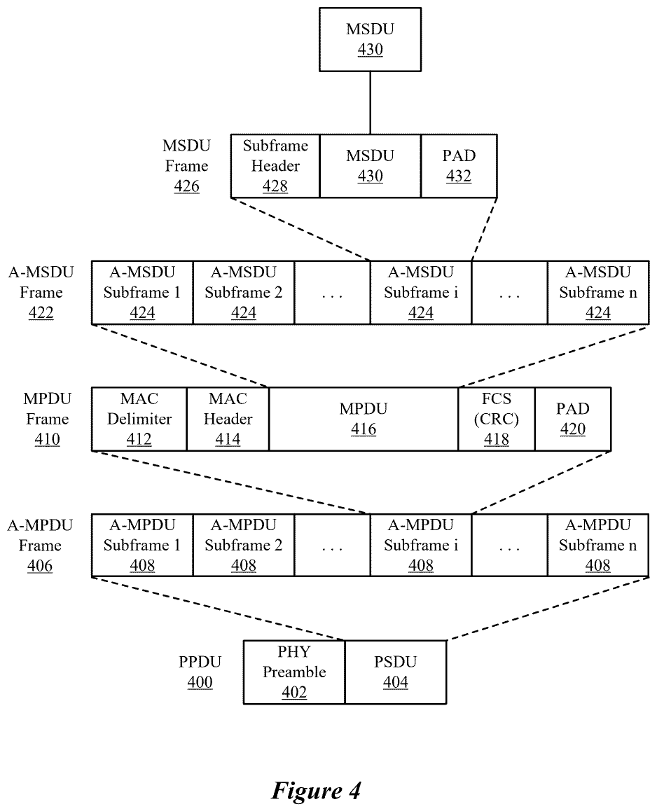

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6-bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other benefits without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described herein.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on CSI associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

In some examples, multiple APs 102 may simultaneously transmit signaling or communications to a single STA 104 utilizing a distributed MU-MIMO scheme. Examples of such a distributed MU-MIMO transmission include COBF (which may be alternatively referred to as “CBF”) and joint transmission (JT). With COBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. COBF allows multiple neighboring APs to transmit simultaneously while minimizing or avoiding interference, which may result in more opportunities for spatial reuse. More specifically, using COBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in COBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

In implementations in which two (or more) APs 102 transmit respective PPDUs 400 in accordance with a COBF communication scheme, the APs 102 may coordinate regarding one or more transmission parameters to be used to transmit parallel ACKs that are in response to the PPDUs 400 and may indicate (via one or more explicit indications or one or more implicit indications, or any combination thereof) the transmission parameter(s) for the parallel ACKs via the PPDUs 400. For example, each PPDU 400 of the two or more coordinated beamformed PPDUs 400 may indicate the transmission parameter(s) defined for the parallel ACKs. A PPDU 400 may indicate the transmission parameter(s) via one or more fields, subfields, or headers, such as via one or more of a PHY preamble 402, a PHY header, a MAC header 414, or any other fields, subfields, or headers as illustrated in any one or more of FIG. 2-4. For example, a PPDU 400 may (implicitly or explicitly) indicate an ACK policy (for the parallel ACKs) via a PHY header or a MAC header of the PPDU 400. In other words, in some examples, the ACK policy may be carried in the PHY header of the PPDU 400. Additionally, or alternatively, the ACK policy may be derived from the MAC header 414 of the MPDUs that are carried in the PPDU 400, such as via an ACK policy field of the QoS control field of the MAC header 414 of data frames or via a type of frame (such that one or more specific types of frames, such as specific types of management frames, at least sometimes imply a specific ACK policy).

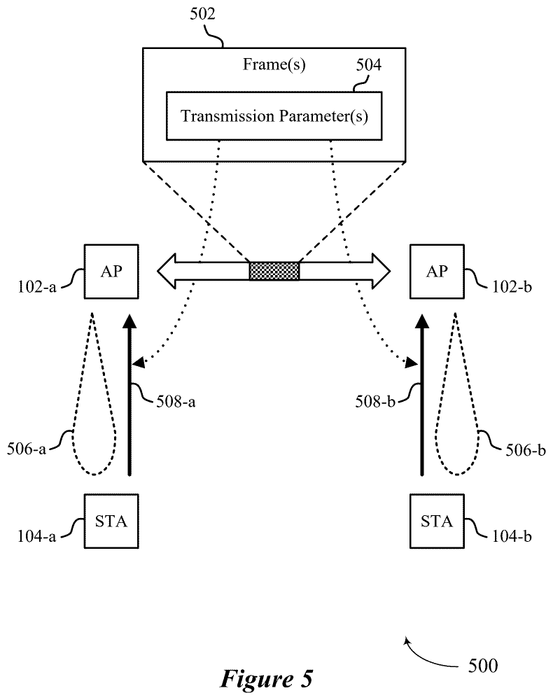

FIG. 5 shows an example signaling diagram 500 that supports parallel ACKs for coordinated beamformed transmissions. The signaling diagram 500 may implement or be implemented to realize or support one or more aspects of the wireless communication network 100, the PPDU 200, the PPDU 350, or the PPDU 400. For example, the signaling diagram 500 illustrates communication between an AP 102-a and an AP 102-b, which may be examples of APs 102 as illustrated by or described with reference to FIG. 1-4. The AP 102-a may define or support a first BSS, and the AP 102-b may define or support a second BSS. A STA 104-a may be associated with (have a wireless connection with) the AP 102-a and a STA 104-b may be associated with (have a wireless connection with) the AP 102-b, with the STA 104-a and the STA 104-b being examples of STAs 104 as illustrated by or described with reference to FIGS. 1-4.

In some aspects, the AP 102-a and the AP 102-b may support COBF (such as a COBF communication scheme) and, to facilitate, enable, or otherwise allow parallel ACKs in response to coordinated beamformed transmissions, the AP 102-a and the AP 102-b may communicate (such as exchange, such as transmit and/or receive) one or more frames 502 to coordinate on one or more transmission parameters 504 for the parallel ACKs. For example, the one or more frames 502 may include information (such as via one or more bits, one or more fields, one or more subfields, or any combination thereof) that defines the one or more transmission parameters 504 for the parallel ACKs. After or as a result of coordinating with each other, the AP 102-a may transmit a first PPDU to the STA 104-a via a first directional beam 506-a and the AP 102-b may transmit a second PPDU to the STA 104-b via a second directional beam 506-b. In some aspects, the first directional beam 506-a and the second directional beam 506-b may be oriented away from each other or otherwise oriented such that transmissions via the first directional beam 506-a and the second directional beam 506-bavoid interfering with each other (or interfere with each other less than a threshold amount).

The first PPDU that the AP 102-a transmits may include first downlink data addressed to the STA 104-a and may include a solicitation for an ACK from the STA 104-a. The second PPDU that the AP 102-b transmits may include second downlink data addressed to the STA 104-b and may include a solicitation for an ACK from the STA 104-b. The first PPDU may solicit (such as trigger or request) an ACK from the STA 104-a via at least one of an explicit indication, an implicit indication, or in accordance with an ACK policy. The second PPDU may solicit (such as trigger or request) an ACK from the STA 104-b via at least one of an explicit indication, an implicit indication, or in accordance with an ACK policy. In some aspects, the first PPDU and the second PPDU may indicate (such as via one or more bits, one or more fields, one or more subfields, or any combination thereof, including implicitly or explicitly) the one or more transmission parameters 504 defined for the parallel ACKs. Additionally, or alternatively, the AP 102-a and the AP 102-b may indicate the one or more transmission parameters 504 via other signaling, such as via one or more management frames (such as a beacon frame or a probe response frame, among other examples).

In accordance with receiving the first PPDU from the AP 102-a (such as in response to the first PPDU), the STA 104-a may transmit an ACK 508-a to the AP 102-a. The STA 104-a may transmit the ACK 508-a in accordance with (such as using or based on) the one or more transmission parameters 504. Additionally, in accordance with receiving the second PPDU from the AP 102-b (such as in response to the second PPDU), the STA 104-b may transmit an ACK 508-b to the AP 102-b. The STA 104-b may transmit the ACK 508-b in accordance with (such as using or based on) the one or more transmission parameters 504. The STA 104-a and the STA 104-b may transmit the ACK 508-a and the ACK 508-b as parallel ACKs, with such a transmission of parallel ACKs in response to coordinated beamformed PPDUs being enabled by use of the one or more transmission parameters 504 that are coordinated between the AP 102-a and the AP 102-b.

In some implementations, the one or more transmission parameters 504 may include an ACK policy (such as a response indication) for the parallel ACKs that are in response to the coordinated beamformed PPDUs. In such implementations, the STA 104-a and the STA 104-b may transmit their respective ACKs (such as block ACKs) according to the ACK policy. The ACK policy may be negotiated in advance (such as prior to the transmission of the coordinated beamformed PPDUs) between the AP 102-a and the AP 102-b, such as via the one or more frames 502. For example, the ACK policy may be agreed on within a COBF agreement establishment phase, may be agreed on within an initial handshake between the two APs at a beginning of a data transmission TXOP (such as a TXOP obtained by or shared with one of the AP 102-a or the AP 102-b), or may be agreed via a vendor-specific frame exchange between the AP 102-a and the AP 102-b. The ACK policy may be “No ACK” (such that no immediate response is expected), “SU-ACK” (normal ACK or implicit block ACK request (BAR), in which the ACK or block ACK may be expected to be carried in a non-trigger based (TB) format PPDU), “TB based ACK” (normal ACK or implicit BAR, in which the ACK or block ACK may be expected to be carried in a TB format PPDU), or “BAR-block ACK (BA)” (such that an explicit block ACK request solicits an ACK or a block ACK).

Additionally, or alternatively, the one or more transmission parameters 504 may include a PPDU length for the parallel ACKs (a length or size of the PPDUs carrying the parallel ACKs) that are in response to the coordinated beamformed PPDUs. In such implementations, the AP 102-a and the AP 102-b may coordinate and agree on the PPDU length to avoid unused airtime in the parallel ACKs. In some aspects, the AP 102-a and the AP 102-b may agree on the PPDU length (which may be understood or referred to as an ACK TB PPDU length) at group formation. Additionally, or alternatively, the AP 102-a and the AP 102-b may agree on the PPDU length more dynamically. For example, a shared AP 102 may indicate a lower limit PPDU length (such as a lower limit length of an ACK TB PPDU) to a sharing AP 102. In such examples, the shared AP 102 may indicate the lower limit PPDU length via a COBF response frame or at any other stage prior to a pre-transmission exchange. The sharing AP 102 may negotiate or comply with the lower limit PPDU length of the shared AP 102. In other words, the sharing AP 102 may perform a final decision on the PPDU length for the parallel ACKs. The sharing AP 102 may indicate the final decision on the PPDU length for the parallel ACKs via a synchronization frame. Additionally, or alternatively, the AP 102-a and the AP 102-b may negotiate, set, or fix the PPDU length for the parallel ACKs via a vendor-specific frame exchange.

To further support time alignment for the parallel ACKs, the STA 104-a and the STA 104-b may pre-correct to the two COBF transmissions (the coordinated beamformed PPDUs, which may have similar if not equal timing and frequency), which may mitigate or resolve issues pertaining to having multiple timing references and frequency references across the two BSSs. Such STA-side pre-correction may be expected under a specific condition, such as in accordance with an MCS being less than a threshold MCS. To further support time alignment for the parallel ACKs, the one or more transmission parameters 504 may additionally, or alternatively, include at least one of a guard interval (GI) plus LTF (GI+LTF) size or a PPDU format (such as an 802.11ax PPDU format, an 802.11be PPDU format, an 802.11bn PPDU format). In other words, the AP 102-a and the AP 102-b may coordinate to use a same GI+LTF size or a same PPDU format, or both, for the parallel ACKs that are in response to the coordinated beamformed PPDUs. In some aspects, use of a same PPDU format across the parallel ACKs may result in symbol level alignment between the parallel ACKs.

Additionally, or alternatively, the one or more transmission parameters 504 may include one or more power control parameters, such as at least one of a target RSSI level for the parallel ACKs, a target transmit power for the parallel ACKs, a threshold RSSI level delta between the parallel ACKs, or a threshold transmit power delta between the parallel ACKs. The AP 102-a and the AP 102-b may coordinate on the power control parameter(s) in accordance with the AP 102-a and the AP 102-b receiving the uplink OFDMA signal (which may include both the ACK 508-a and the ACK 508-b). Further, the AP 102-a and the AP 102-b may coordinate on the power control parameter(s) in accordance with there being two quantities two manage, the two quantities including a receive power level for the in-BSS AP 102 (which may be set to a specific level such that all ACKs in that BSS arrive at similar levels) and an interference level caused to the OBSS AP (where this level may be expected to be lower than 1, such as if there is greater than 0 dB isolation between the first directional beam 506-a and the second directional beam 506-b).

In accordance with coordinating on the power control parameter(s), the AP 102-a and the AP 102-b may control, manage, or otherwise influence transmit powers at the STA 104-a and the STA 104-b, respectively, such that interference caused at a BSS is within a threshold range of the in-BSS target RSSI level requested in that BSS, which may be achieved by using similar in-BSS target RSSI levels (such that the two in-BSS target RSSI levels are within a threshold range of each other). The AP 102-a and the AP 102-b may coordinate on the power control parameter(s) at group formation, pre-transmission (such as prior, such as immediately prior, to the coordinated beamformed PPDUs), or via a vendor-specific frame exchange. The coordinated power control parameter(s) may include the ACK target RSSI levels at the AP 102-a and the AP 102-b and the coordination may enable the AP 102-a and the AP 102-b to set the ACK target RSSI levels within a threshold range of each other. For example, the AP 102-a may indicate a first ACK target RSSI level, and the AP 102-b may indicate a second ACK target RSSI level that is within the threshold range of the first ACK target RSSI level (in accordance with the inter-AP coordination). In some aspects, the AP 102-a and the AP 102-b may select the target RSSI levels to be the same for the parallel ACKs (such that the first ACK target RSSI level is equal to the second ACK target RSSI level). The AP 102-a and the AP 102-b may additionally, or alternatively, select a same modulation and coding scheme (MCS) for the parallel ACKs, with the MCS being fixed (such as static, such as in accordance with a vendor-specified value or a network-defined value) or coordinated between the AP 102-a and the AP 102-b via the one or more frames 502 (such that the one or more transmission parameters 504 include the MCS for the parallel ACKs).

Additionally, or alternatively, the one or more transmission parameters 504 may include an RU assignment for the parallel ACKs that are in response to the coordinated beamformed PPDUs. In some aspects, an overall PPDU bandwidth for the ACK may be the same as a bandwidth of the coordinated beamformed PPDUs. To avoid a collision between the ACK 508-a and the ACK 508-b, in examples in which the coordinated beamformed PPDUs are transmitted over a bandwidth, the AP 102-a and the AP 102-b may (via coordination) split the bandwidth in half for the parallel ACKs (such as for the TB ACKs across the AP 102-a and the AP 102-b). For example, a sharing AP 102 may use a first half of the bandwidth for the ACK to the sharing AP 102 and the shared AP 102 may use a second (other) half of the bandwidth for the ACK to the shared AP 102. By way of further example, the ACK 508-a may use (and, in some implementations, indicate) a first transmission bandwidth and the ACK 508-b may use (and, in some implementations, indicate) a second transmission bandwidth. The first transmission bandwidth and the second transmission bandwidth may be the same. In examples in which an overall bandwidth is 40 MHz, the first and second transmission bandwidths may each be 20 MHz. In examples in which an overall bandwidth is 80 MHz, the first and second transmission bandwidths may each be 40 MHz. Alternatively, the first transmission bandwidth and the second transmission bandwidth may be different transmission bandwidths. In such implementations, a sharing AP 102 may assign (such as allocate) a larger portion of the bandwidth to its associated STA 104 as compared to a shared AP 102.

In some aspects, the sharing AP 102 may have a priority selection of which half of the bandwidth to use for the ACK to the sharing AP 102. For example, in scenarios in which there is channel (or subchannel) puncturing, the sharing AP 102 may have priority to select an unpunctured (or less punctured) half of the bandwidth for the ACK to the sharing AP 102 (which may provide relatively more bandwidth for the ACK to the sharing AP 102, which may increase a likelihood of successful reception of the ACK to the sharing AP 102). The AP 102-a and the AP 102-b may coordinate on the RU assignment in a pre-transmission exchange (such as a frame exchange prior, such as immediately prior, to the coordinated beamformed PPDUs). For example, a sharing AP 102 may select and indicate which half of the bandwidth the sharing AP 102 will allocate to its associated STA 104 via an invite frame and a shared AP 102 may (such as in accordance with a network-defined behavior or expectation) allocate the other half of the bandwidth to its associated STA 104. The AP 102-a may assign one or more first RUs to the STA 104-a within the portion of the bandwidth selected by the AP 102-a and the AP 102-b may assign one or more second RUs to the STA 104-b within the portion of the bandwidth selected by the AP 102-b.

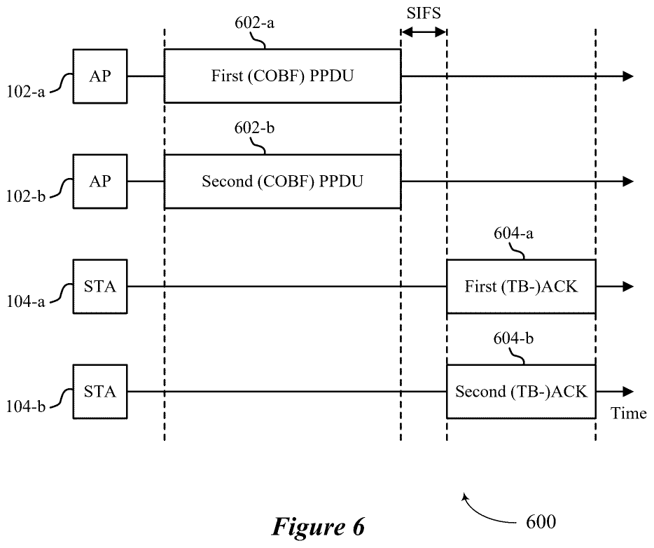

FIG. 6 shows an example communication timeline 600 that supports parallel ACKs for coordinated beamformed transmissions. The communication timeline 600 may implement or be implemented to realize or support one or more aspects of the wireless communication network 100, the PPDU 200, the PPDU 350, the PPDU 400, or the signaling diagram 500. For example, the communication timeline 600 illustrates communication between an AP 102-a, an AP 102-b, a STA 104-a, and a STA 104-b, which may be examples of corresponding devices as illustrated by and described with reference to FIGS. 1-5 .

In some aspects, the AP 102-a and the AP 102-b may transmit coordinated beamformed PPDUs including a first PPDU 602-a transmitted by the AP 102-a and a second PPDU 602-b transmitted by the AP 102-b. By way of example, the AP 102-a may transmit the first PPDU 602-a via a first directional communication beam, such as the first directional beam 506-a as illustrated by and described with reference to FIG. 5. By way of further example, the AP 102-b may transmit the second PPDU 602-b via a second directional communication beam, such as the second directional beam 506-b as illustrated by and described with reference to FIG. 5. The first PPDU 602-a may include downlink data addressed to the STA 104-a and may include a solicitation for a first ACK 604-a (such as a TB-ACK) from the STA 104-a. The second PPDU 602-b may include downlink data addressed to the STA 104-b and may include a solicitation for a second ACK 604-b (such as a TB-ACK) from the STA 104-b. At least one of the first PPDU 602-a or the second PPDU 602-b may indicate one or more transmission parameters defined for the first ACK 604-a and the second ACK 604-b, such as the one or more transmission parameters 504 as illustrated by and described with reference to FIG. 5.

The STA 104-a and the STA 104-b may transmit the first ACK 604-a and the second ACK 604-b, respectively, as parallel ACKs in response to the first PPDU 602-a and the second PPDU 602-b (such as in response to the coordinated beamformed PPDUs). In some implementations, the STA 104-a and the STA 104-b may transmit the first ACK 604-a and the second ACK 604-b, respectively, as parallel ACKs by transmitting the first ACK 604-a and the second ACK 604-b in accordance with the one or more transmission parameters 504. The first ACK 604-a and the second ACK 604-b may be transmitted at (approximately) a same time (with PPDU time alignment) and via different frequency channels (such as via different portions of an overall channel bandwidth of the first PPDU 602-a and the second PPDU 602-b).

In some implementations, the first ACK 604-a and the second ACK 604-b may be part of a single wideband OFDMA transmission, with the first ACK 604-a and the second ACK 604-b (the ACKs in the two BSSs) being assigned (such as allocated) one or more RUs in different parts of the overall OFDMA transmission bandwidth. In such implementations, the first ACK 604-a and the second ACK 604-b may appear (such as to another device in the network) as a single wideband transmission (such as a single ACK or a single block ACK), such as if the first ACK 604-a and the second ACK 604-b were transmitted within a same PPDU. To appear as a single wideband OFDMA transmission, the first ACK 604-a and the second ACK 604-b may use a common (such as a same) BSS color and each may indicate (such as signal) the overall PPDU bandwidth. Further, the first ACK 604-a and the second ACK 604-b may be consistent (such as aligned, synchronized, or the same) on other PPDU contents, such as on other contents within the TB PPDU U-SIG (such as at least one of a spatial reuse (SR) field or an L-SIG length). In some implementations, the values of the contents on which the first ACK 604-a and the second ACK 604-b are consistent may be defined by a network specification. Additionally, or alternatively, the values/lengths of the contents for which the first ACK 604-a and the second ACK 604-b are consistent may be coordinated or (re-)negotiated (by the AP 102-a and the AP 102-b) in one or more preceding packets.

In some aspects, the solicitation (such as the trigger) embedded within each of the first PPDU 602-a and the second PPDU 602-b may signal, to the STA 104-a and the STA 104-b, which BSS color to use and a bandwidth, with the bandwidth being the entire ACK PPDU bandwidth spanning the bandwidth of the ACKs in both BSSs (the first ACK 604-a and the second ACK 604-b). The BSS color indicated for the parallel ACKs may be the BSS color of the AP 102-a, the BSS color of the AP 102-b, the BSS color of a TXOP sharing AP 102, or a default or special BSS color value (such as a BSS color specifically or dedicatedly used for parallel ACKs in response to coordinated beamformed PPDUs, such as a BSS color value of 0). To enable both the STA 104-a and the STA 104-b to use a same BSS color value (despite being of different BSSs), the STA 104-a and the STA 104-b may support a capability to use a BSS color different than the BSS color of its BSS. The STA 104-a and the STA 104-b may transmit a frame indicative of such STA-side capability or may be expected to have such STA-side capability in accordance with being of a specific generation (such as to comply with a specific 802.11 specification or standard amendment), among other examples.

In some implementations, the first ACK 604-a and the second ACK 604-b may be transmitted within independent PPDUs. For example, the first ACK 604-a may be transmitted within a first PPDU (such as a first TB PPDU) and the second ACK 604-b may be transmitted within a second PPDU (such as a second TB PPDU) independent of (such as separate from) the first PPDU. In other words, the first ACK 604-a and the second ACK 604-b may be frequency duplexed (FD) aggregated PPDU (APPDU) using OFDMA, each having a respective (and different) BSS color and a respective (and different) channel bandwidth. For example, BSS color and other parameters may be individual for the PPDU carrying (such as including) the first ACK 604-a and the PPDU carrying (such as including) the second ACK 604-b. In such implementations, the first ACK 604-a and the second ACK 604-b may still have OFDM symbol alignment (which may result from or be facilitated by the coordination or collaboration between the AP 102-a and the AP 102-b on the one or more transmission parameters 504).

In some implementations, the first ACK 604-a and the second ACK 604-b may indicate a same overall PPDU bandwidth (such that the first ACK 604-a and the second ACK 604-b may each “pretend” to be a wider bandwidth PPDU). In some other implementations, the first ACK 604-a may indicate a first channel bandwidth (such as a first set of one or more frequency channels) and the second ACK 604-b may indicate a second channel bandwidth (such as a second set of one or more frequency channels). In other words, each ACK may signal its individual (such as respective) bandwidth and the corresponding PPDU may be transmitted in the appropriate section of the spectrum. Such different bandwidths may be, for example, an upper 20 MHz channel/bandwidth and a lower 20 MHz channel/bandwidth, an upper 40 MHz channel/bandwidth and a lower 40 MHz channel/bandwidth, an upper 80 MHz channel/bandwidth and a lower 80 MHz channel/bandwidth, or an upper 160 MHz channel/bandwidth and a lower 160 MHz channel/bandwidth, among other examples. To support an indication of individual bandwidths in each ACK, at least one of the STA 104-a or the STA 104-b may support non-primary channel access (NPCA) or dynamic subchannel operation (DSO).

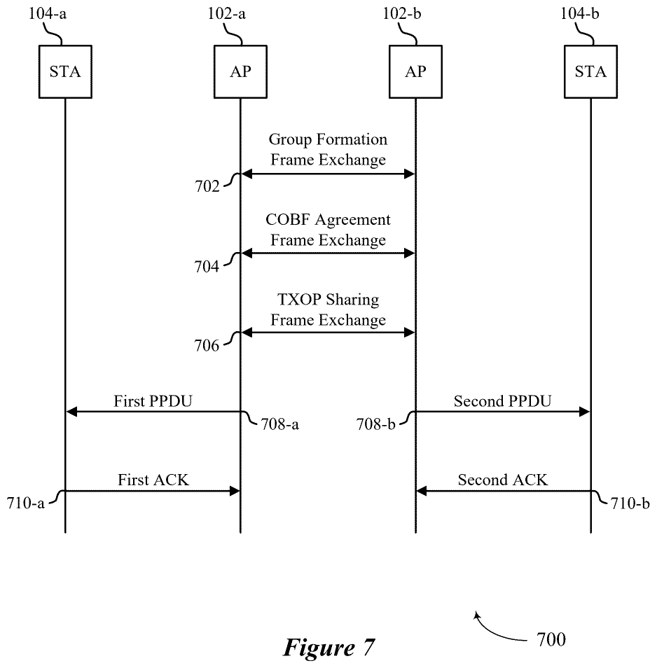

FIG. 7 shows an example process flow 700 that supports parallel ACKs for coordinated beamformed transmissions. The process flow 700 may implement or be implemented to realize or support one or more aspects of the wireless communication network 100, the PPDU 200, the PPDU 350, the PPDU 400, the signaling diagram 500, or the communication timeline 600. For example, the process flow 700 illustrates communication between an AP 102-a, an AP 102-b, a STA 104-a, and a STA 104-b, which may be examples of corresponding devices as illustrated by and described with reference to FIGS. 1-6 .

In the following description of the process flow 700, the operations may be performed in different orders or at different times. Some operations also may be left out of the process flow 700, or other operations may be added. Although some example devices are shown performing the operations of the process flow 700, some aspects of some operations also may be performed by one or more other devices.

At 702, the AP 102-a and the AP 102-b may communicate (such as transmit and/or receive) one or more frames as part of a group formation frame exchange. For example, the AP 102-a and the AP 102-b may form or join a group of coordinating or “friendly” APs 102 and may communicate one or more frames as part of forming or joining the group. In some aspects, the one or more frames that the AP 102-a and the AP 102-b communicate as part of the group formation frame exchange may include information that defines one or more transmission parameters (such as the one or more transmission parameters 504) for parallel ACKs that are in response to coordinated beamformed PPDUs. The frame(s) of the group formation frame exchange may include one or more network-defined frames or one or more vendor-specific frames, or any combination thereof.

At 704, the AP 102-a and the AP 102-b may communicate (such as transmit and/or receive) one or more frames as part of a COBF agreement frame exchange. For example, the AP 102-a and the AP 102-b may agree to perform COBF for one or more upcoming transmissions and may communicate one or more frames to synchronize on one or more COBF parameters in advance of the COBF transmissions. Such one or more frames that are part of a COBF agreement frame exchange may include at least one of an invite frame, a response frame, or a synchronization frame. In some aspects, the one or more frames that the AP 102-a and the AP 102-b communicate as part of the COBF agreement frame exchange may include information that defines one or more transmission parameters (such as the one or more transmission parameters 504) for parallel ACKs that are in response to coordinated beamformed PPDUs. The frame(s) of the COBF agreement frame exchange may include one or more network-defined frames or one or more vendor-specific frames, or any combination thereof.

At 706, the AP 102-a and the AP 102-b may communicate (such as transmit and/or receive) one or more frames as part of a TXOP sharing frame exchange. For example, one of the AP 102-a or the AP 102-b may obtain (such as acquire) a TXOP, may determine to share at least a portion of the TXOP with the other of the AP 102-a or the AP 102-b, and may communicate one or more frames to coordinate on the TXOP sharing. For example, the AP 102-a may transmit a TXS frame to the AP 102-b, or vice versa. In some aspects, the one or more frames that the AP 102-a and the AP 102-b communicate as part of the TXOP sharing frame exchange may include information that defines one or more transmission parameters (such as the one or more transmission parameters 504) for parallel ACKs that are in response to coordinated beamformed PPDUs. The frame(s) of the TXOP sharing frame exchange may include one or more network-defined frames or one or more vendor-specific frames, or any combination thereof.

At 708-a, the AP 102-a may transmit a first PPDU in accordance with a COBF communication scheme between the AP 102-a and the AP 102-b. The first PPDU may include downlink data addressed to the STA 104-a and may include a solicitation for a first ACK from the STA 104-a in response to the first PPDU. At 708-b, the AP 102-b may transmit a second PPDU in accordance with the COBF communication scheme between the AP 102-a and the AP 102-b. The second PPDU may include downlink data addressed to the STA 104-b and may include a solicitation for a second ACK from the STA 104-b in response to the second PPDU. In some implementations, the first PPDU and the second PPDU may indicate the one or more transmission parameters defined for the parallel ACKs that are in response to coordinated beamformed PPDUs.

At 710-a, the STA 104-a may transmit the first ACK in accordance with receiving the first PPDU (such as in accordance with the solicitation within the first PPDU) and in accordance with the one or more transmission parameters defined for the parallel ACKs that are in response to coordinated beamformed PPDUs. At 710-b, the STA 104-b may transmit the second ACK in accordance with receiving the second PPDU (such as in accordance with the solicitation within the second PPDU) and in accordance with the one or more transmission parameters defined for the parallel ACKs that are in response to coordinated beamformed PPDUs. By transmitting the first ACK and the second ACK in accordance with the transmission parameter(s) defined for the parallel ACKs that are in response to coordinated beamformed PPDUs, the first ACK and the second ACK may be transmitted as parallel ACKs in a manner that reduces signaling overhead while maintaining communication reliability.

By way of example, the AP 102-a and the AP 102-b may agree to at least one of a power control strategy, one or more OFDM symbol alignment related parameters, or a TB ACK PPDU length (such as via one or more frames, such as via one or more vendor-specific frames or one or more network-defined frames). The ACK policy/response indication sent to the STA 104-a and the STA 104-b may indicate TB ACK (such as TB-based ACK). The coordinated beamformed transmissions by the AP 102-a and the AP 102-b may include respective trigger portions (such as trigger frames), with the two trigger portions allocating orthogonal frequency resources to the STA 104-a and the STA 104-b for transmitting the ACKs. In some aspects, a bandwidth field of the responses (the ACKs) may be set to indicate an overall bandwidth, the BSS colors may be different in the two portions of the overall bandwidth, and the AP 102-a and the AP 102-b may configure the GI+LTF and spatial streams, among other parameters, are aligned to facilitate (such as result in) OFDM symbol alignment. In such an example, the first ACK and the second ACK may be transmitted via separate (such as independent) PPDUs that are aligned in OFDM symbols and that “pretend” (such as appear, such as to another device in the network) to be a larger bandwidth OFDMA PPDU with different BSS colors.

In some implementations, the AP 102-a and the AP 102-b may further support coordinated spatial reuse (CSR). In CSR, packets (such as PPDUs) may not end at the exact same time, which may cause the AP 102-a and the AP 102-b to refrain from soliciting parallel ACKs that are in response to CSR PPDUs. In such implementations, the AP 102-a and the AP 102-b may instead solicit sequential ACKs, such that ACKs for CSR PPDUs may be sequential. For example, the AP 102-a and the AP 102-b may coordinate to have immediate ACK as the policy for the PPDU that ends later, and delayed ACK as the policy for the PDU that ends earlier.

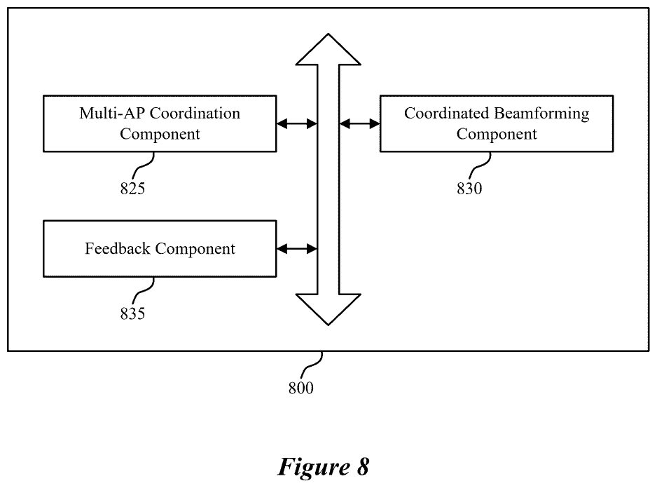

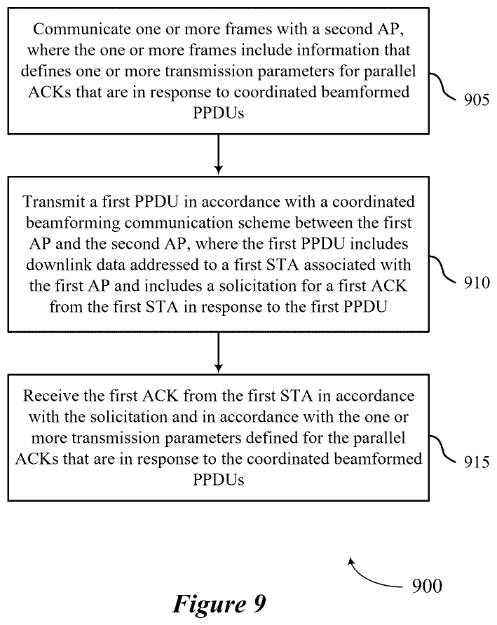

FIG. 8 shows a block diagram of an example wireless communication device 800 that supports parallel ACKs for coordinated beamformed transmissions. In some examples, the wireless communication device 800 is configured to perform the process 900 described with reference to FIG. 9. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes a multi-AP coordination component 825, a coordinated beamforming component 830, and a feedback component 835. Portions of one or more of the multi-AP coordination component 825, the coordinated beamforming component 830, and the feedback component 835 may be implemented at least in part in hardware or firmware. For example, one or more of the multi-AP coordination component 825, the coordinated beamforming component 830, and the feedback component 835 may be implemented at least in part by at least a processor or a modem. In some examples, portions of one or more of the multi-AP coordination component 825, the coordinated beamforming component 830, and the feedback component 835 may be implemented at least in part by a processor and software in the form of processor-executable code stored in memory.

The wireless communication device 800 may support wireless communication in accordance with examples as disclosed herein. The multi-AP coordination component 825 is configurable or configured to communicate one or more frames with a second AP, where the one or more frames include information that defines one or more transmission parameters for parallel ACKs that are in response to coordinated beamformed PPDUs. The coordinated beamforming component 830 is configurable or configured to transmit a first PPDU in accordance with a coordinated beamforming communication scheme between the first AP and the second AP, where the first PPDU includes downlink data addressed to a first STA associated with the first AP and includes a solicitation for a first ACK from the first STA in response to the first PPDU. The feedback component 835 is configurable or configured to receive the first ACK from the first STA in accordance with the solicitation and in accordance with the one or more transmission parameters defined for the parallel ACKs that are in response to the coordinated beamformed PPDUs.

In some examples, the first PPDU indicates the first STA to use the one or more transmission parameters for transmission of the first ACK.

In some examples, the one or more frames are communicated with the second AP as part of at least one of a coordinated beamforming agreement establishment phase between the first AP and the second AP, an initial handshake between the first AP and the second AP at a beginning of a transmission opportunity (TXOP) within which the first PPDU is transmitted, or a group formation between a set of multiple coordinating APs including the first AP and the second AP.

In some examples, the one or more transmission parameters include an ACK policy for the parallel ACKs that are in response to the coordinated beamformed PPDUs.

In some examples, the first PPDU indicates the ACK policy via an ACK policy indicator within a physical layer header of the first PPDU or via a type of a frame within the first PPDU.

In some examples, the one or more transmission parameters include a PPDU length for the parallel ACKs that are in response to the coordinated beamformed PPDUs.

In some examples, the one or more transmission parameters include a target RSSI level for the parallel ACKs that are in response to the coordinated beamformed PPDUs or an upper limit target RSSI level delta between the parallel ACKs that are in response to the coordinated beamformed PPDUs.

In some examples, the one or more transmission parameters include at least one of a transmit power for the parallel ACKs that are in response to the coordinated beamformed PPDUs or an upper limit transmit power delta between the parallel ACKs that are in response to the coordinated beamformed PPDUs.

In some examples, the one or more transmission parameters include a modulation and coding scheme for the parallel ACKs that are in response to the coordinated beamformed PPDUs.

In some examples, the one or more transmission parameters include a resource unit assignment for the parallel ACKs that are in response to the coordinated beamformed PPDUs.

In some examples, the resource unit assignment is in accordance with which of the first AP or the second AP is a sharing AP.

In some examples, the one or more transmission parameters include at least one of a GI+LTF size or a PPDU format for the parallel ACKs that are in response to the coordinated beamformed PPDUs.

In some examples, the parallel ACKs that are in response to the coordinated beamformed PPDUs include the first ACK in response to the first PPDU transmitted by the first AP and a second ACK in response to a second PPDU transmitted by the second AP. In some examples, the coordinated beamformed PPDUs include the first PPDU and the second PPDU.

In some examples, the first ACK and the second ACK are part of a single wideband OFDMA transmission.

In some examples, each of the first ACK and the second ACK indicate a same BSS color and indicate a same overall transmission bandwidth that spans the single wideband OFDMA transmission. In some examples, the first ACK is transmitted via a first resource unit assignment within a first portion of the same overall transmission bandwidth and the second ACK is transmitted via a second resource unit assignment within a second portion of the same overall transmission bandwidth.

In some examples, the one or more transmission parameters include at least one of the same BSS color, the same overall transmission bandwidth, the first resource unit assignment, or the second resource unit assignment.

In some examples, the one or more transmission parameters further include at least one of a same content of a U-SIG field or a same L-SIG field length for the parallel ACKs that are in response to the coordinated beamformed PPDUs.

In some examples, the first ACK is within a first PPDU transmitted via a first set of one or more channels and the second ACK is within a second PPDU, independent from the first PPDU, transmitted via a second set of one or more channels.

In some examples, the first PPDU indicates a first BSS color and the second PPDU indicates a second BSS color.

In some examples, each of the first PPDU and the second PPDU indicate a same overall transmission bandwidth that spans the first set of one or more channels and the second set of one or more channels.

In some examples, the one or more transmission parameters include the same overall transmission bandwidth.

In some examples, the first PPDU indicates a first transmission bandwidth that spans the first set of one or more channels and the second PPDU indicates a second transmission bandwidth that spans the second set of one or more channels.

FIG. 9 shows a flowchart illustrating an example process 900 performable by or at a first AP that supports parallel ACKs for coordinated beamformed transmissions. The operations of the process 900 may be implemented by a first AP or its components as described herein. For example, the process 900 may be performed by a wireless communication device, such as the wireless communication device 800 described with reference to FIG. 8, operating as or within a wireless AP. In some examples, the process 900 may be performed by a wireless AP, such as one of the APs 102 described with reference to FIG. 1.

In some examples, in 905, the first AP may communicate one or more frames with a second AP, where the one or more frames include information that defines one or more transmission parameters for parallel ACKs that are in response to coordinated beamformed PPDUs. In some implementations, aspects of the operations of 905 may be performed by a multi-AP coordination component 825 as described with reference to FIG. 8.

In some examples, in 910, the first AP may transmit a first PPDU in accordance with a coordinated beamforming communication scheme between the first AP and the second AP, where the first PPDU includes downlink data addressed to a first STA associated with the first AP and includes a solicitation for a first ACK from the first STA in response to the first PPDU. In some implementations, aspects of the operations of 910 may be performed by a coordinated beamforming component 830 as described with reference to FIG. 8.

In some examples, in 915, the first AP may receive the first ACK from the first STA in accordance with the solicitation and in accordance with the one or more transmission parameters defined for the parallel ACKs that are in response to the coordinated beamformed PPDUs. In some implementations, aspects of the operations of 915 may be performed by a feedback component 835 as described with reference to FIG. 8.

Implementation examples are described in the following numbered clauses:
Clause 1: A method for wireless communication at a first AP, including: communicating one or more frames with a second AP, where the one or more frames include information that defines one or more transmission parameters for parallel ACKs that are in response to coordinated beamformed PPDUs; transmitting a first PPDU in accordance with a COBF communication scheme between the first AP and the second AP, where the first PPDU includes downlink data addressed to a first STA associated with the first AP and includes a solicitation for a first ACK from the first STA in response to the first PPDU; and receiving the first ACK from the first STA in accordance with the solicitation and in accordance with the one or more transmission parameters defined for the parallel ACKs that are in response to the coordinated beamformed PPDUs.
Clause 2: The method of clause 1, where the first PPDU indicates the first STA to use the one or more transmission parameters for transmission of the first ACK.
Clause 3: The method of any of clauses 1-2, where the one or more frames are communicated with the second AP as part of at least one of a COBF agreement establishment phase between the first AP and the second AP, an initial handshake between the first AP and the second AP at a beginning of a TXOP within which the first PPDU is transmitted, or a group formation between a plurality of coordinating APs including the first AP and the second AP.
Clause 4: The method of any of clauses 1-3, where the one or more transmission parameters include an ACK policy for the parallel ACKs that are in response to the coordinated beamformed PPDUs.
Clause 5: The method of clause 4, where the first PPDU indicates the ACK policy via an ACK policy indicator within a physical layer header of the first PPDU or via a type of a frame within the first PPDU.
Clause 6: The method of any of clauses 1-5, where the one or more transmission parameters include a PPDU length for the parallel ACKs that are in response to the coordinated beamformed PPDUs.
Clause 7: The method of any of clauses 1-6, where the one or more transmission parameters include a target RSSI level for the parallel ACKs that are in response to the coordinated beamformed PPDUs or an upper limit target RSSI level delta between the parallel ACKs that are in response to the coordinated beamformed PPDUs.
Clause 8: The method of any of clauses 1-7, where the one or more transmission parameters include at least one of a transmit power for the parallel ACKs that are in response to the coordinated beamformed PPDUs or an upper limit transmit power delta between the parallel ACKs that are in response to the coordinated beamformed PPDUs.
Clause 9: The method of any of clauses 1-8, where the one or more transmission parameters include an MCS for the parallel ACKs that are in response to the coordinated beamformed PPDUs.
Clause 10: The method of any of clauses 1-9, where the one or more transmission parameters include an RU assignment for the parallel ACKs that are in response to the coordinated beamformed PPDUs.
Clause 11: The method of clause 10, where the resource unit assignment is in accordance with which of the first AP or the second AP is a sharing AP.
Clause 12: The method of any of clauses 1-11, where the one or more transmission parameters include at least one of a GI+LTF size or a PPDU format for the parallel ACKs that are in response to the coordinated beamformed PPDUs.
Clause 13: The method of any of clauses 1-12, where the parallel ACKs that are in response to the coordinated beamformed PPDUs include the first ACK in response to the first PPDU transmitted by the first AP and a second ACK in response to a second PPDU transmitted by the second AP, and the coordinated beamformed PPDUs include the first PPDU and the second PPDU.
Clause 14: The method of clause 13, where the first ACK and the second ACK are part of a single wideband OFDMA transmission.
Clause 15: The method of clause 14, where each of the first ACK and the second ACK indicate a same BSS color and indicate a same overall transmission bandwidth that spans the single wideband OFDMA transmission, and the first ACK is transmitted via a first resource unit assignment within a first portion of the same overall transmission bandwidth and the second ACK is transmitted via a second resource unit assignment within a second portion of the same overall transmission bandwidth.
Clause 16: The method of clause 15, where the one or more transmission parameters include at least one of the same BSS color, the same overall transmission bandwidth, the first resource unit assignment, or the second resource unit assignment.
Clause 17: The method of clause 16, where the one or more transmission parameters further include at least one of a same content of a U-SIG field or a same L-SIG field length for the parallel ACKs that are in response to the coordinated beamformed PPDUs.
Clause 18: The method of any of clauses 13-17, where the first ACK is within a first PPDU transmitted via a first set of one or more channels and the second ACK is within a second PPDU, independent from the first PPDU, transmitted via a second set of one or more channels.
Clause 19: The method of clause 18, where the first PPDU indicates a first BSS color and the second PPDU indicates a second BSS color.
Clause 20: The method of any of clauses 18-19, where each of the first PPDU and the second PPDU indicate a same overall transmission bandwidth that spans the first set of one or more channels and the second set of one or more channels.
Clause 21: The method of clause 20, where the one or more transmission parameters include the same overall transmission bandwidth.
Clause 22: The method of any of clauses 18-21, where the first PPDU indicates a first transmission bandwidth that spans the first set of one or more channels and the second PPDU indicates a second transmission bandwidth that spans the second set of one or more channels.
Clause 23: A first AP for wireless communication, including a processing system that includes processor circuitry and memory circuitry that stores code, the processing system configured to cause the first AP to perform a method of any of clauses 1-22.
Clause 24: A first AP for wireless communication, including at least one means for performing a method of any of clauses 1-22.
Clause 25: A non-transitory computer-readable medium storing code for wireless communication, the code including instructions executable by one or more processors to (cause a first AP to) perform a method of any of clauses 1-22.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless2 otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be implemented. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
communicate one or more frames with a second AP, wherein the one or more frames comprise information that defines one or more transmission parameters for parallel acknowledgments that are in response to coordinated beamformed physical layer protocol data units (PPDUs);
transmit a first PPDU in accordance with a coordinated beamforming communication scheme between the first AP and the second AP, wherein the first PPDU comprises downlink data addressed to a first station (STA) associated with the first AP and comprises a solicitation for a first acknowledgment from the first STA in response to the first PPDU; and
receive the first acknowledgment from the first STA in accordance with the solicitation and in accordance with the one or more transmission parameters defined for the parallel acknowledgments that are in response to the coordinated beamformed PPDUs.

2. The first AP of claim 1, wherein the first PPDU indicates the first STA to use the one or more transmission parameters for transmission of the first acknowledgment.

3. The first AP of claim 1, wherein the one or more frames are communicated with the second AP as part of at least one of:
a coordinated beamforming agreement establishment phase between the first AP and the second AP,
an initial handshake between the first AP and the second AP at a beginning of a transmission opportunity (TXOP) within which the first PPDU is transmitted, or
a group formation between a plurality of coordinating APs including the first AP and the second AP.

4. The first AP of claim 1, wherein the one or more transmission parameters comprise an acknowledgment policy for the parallel acknowledgments that are in response to the coordinated beamformed PPDUs.

5. The first AP of claim 4, wherein the first PPDU indicates the acknowledgment policy via an acknowledgment policy indicator within a physical layer header of the first PPDU or via a type of a frame within the first PPDU.

6. The first AP of claim 1, wherein the one or more transmission parameters comprise a PPDU length for the parallel acknowledgments that are in response to the coordinated beamformed PPDUs.

7. The first AP of claim 1, wherein the one or more transmission parameters comprise a target received signal strength indicator (RSSI) level for the parallel acknowledgments that are in response to the coordinated beamformed PPDUs or an upper limit target RSSI level delta between the parallel acknowledgments that are in response to the coordinated beamformed PPDUs.

8. The first AP of claim 1, wherein the one or more transmission parameters comprise at least one of a transmit power for the parallel acknowledgments that are in response to the coordinated beamformed PPDUs or an upper limit transmit power delta between the parallel acknowledgments that are in response to the coordinated beamformed PPDUs.

9. The first AP of claim 1, wherein the one or more transmission parameters comprise a modulation and coding scheme for the parallel acknowledgments that are in response to the coordinated beamformed PPDUs.

10. The first AP of claim 1, wherein the one or more transmission parameters comprise a resource unit assignment for the parallel acknowledgments that are in response to the coordinated beamformed PPDUs.

11. The first AP of claim 10, wherein the resource unit assignment is in accordance with which of the first AP or the second AP is a sharing AP.

12. The first AP of claim 1, wherein the one or more transmission parameters comprise at least one of a guard interval plus long training field (GI+LTF) size or a PPDU format for the parallel acknowledgments that are in response to the coordinated beamformed PPDUs.

13. A method for wireless communication at a first access point (AP), comprising:
communicating one or more frames with a second AP, wherein the one or more frames comprise information that defines one or more transmission parameters for parallel acknowledgments that are in response to coordinated beamformed physical layer protocol data units (PPDUs);
transmitting a first PPDU in accordance with a coordinated beamforming communication scheme between the first AP and the second AP, wherein the first PPDU comprises downlink data addressed to a first station (STA) associated with the first AP and comprises a solicitation for a first acknowledgment from the first STA in response to the first PPDU; and
receiving the first acknowledgment from the first STA in accordance with the solicitation and in accordance with the one or more transmission parameters defined for the parallel acknowledgments that are in response to the coordinated beamformed PPDUs.

14. The method of claim 13, wherein:
the parallel acknowledgments that are in response to the coordinated beamformed PPDUs comprise the first acknowledgment in response to the first PPDU transmitted by the first AP and a second acknowledgment in response to a second PPDU transmitted by the second AP, and
the coordinated beamformed PPDUs comprise the first PPDU and the second PPDU.

15. The method of claim 14, wherein the first acknowledgment and the second acknowledgment are part of a single wideband orthogonal frequency division multiple access (OFDMA) transmission.

16. The method of claim 15, wherein:
each of the first acknowledgment and the second acknowledgment indicate a same basic service set (BSS) color and indicate a same overall transmission bandwidth that spans the single wideband OFDMA transmission, and
the first acknowledgment is transmitted via a first resource unit assignment within a first portion of the same overall transmission bandwidth and the second acknowledgment is transmitted via a second resource unit assignment within a second portion of the same overall transmission bandwidth.

17. The method of claim 14, wherein the first acknowledgment is within a first PPDU transmitted via a first set of one or more channels and the second acknowledgment is within a second PPDU, independent from the first PPDU, transmitted via a second set of one or more channels.

18. The method of claim 17, wherein the first PPDU indicates a first basic service set (BSS) color and the second PPDU indicates a second BSS color.

19. The method of claim 17, wherein:
each of the first PPDU and the second PPDU indicate a same overall transmission bandwidth that spans the first set of one or more channels and the second set of one or more channels; or
the first PPDU indicates a first transmission bandwidth that spans the first set of one or more channels and the second PPDU indicates a second transmission bandwidth that spans the second set of one or more channels.

20. A first access point (AP) for wireless communication, comprising:
means for communicating one or more frames with a second AP, wherein the one or more frames comprise information that defines one or more transmission parameters for parallel acknowledgments that are in response to coordinated beamformed physical layer protocol data units (PPDUs);
means for transmitting a first PPDU in accordance with a coordinated beamforming communication scheme between the first AP and the second AP, wherein the first PPDU comprises downlink data addressed to a first station (STA) associated with the first AP and comprises a solicitation for a first acknowledgment from the first STA in response to the first PPDU; and
means for receiving the first acknowledgment from the first STA in accordance with the solicitation and in accordance with the one or more transmission parameters defined for the parallel acknowledgments that are in response to the coordinated beamformed PPDUs.
